(19) United States
(12) Patent Application Publication
(10) Pub. No.: US 2022/0363280 A1
(43) Pub. Date: Nov. 17, 2022

(54) Calibration Adjustment For Automatic Steering Systems

(71) Applicant: Ag Leader Technology, Ames, IA (US)

(72) Inventor: Josue Calderon, Ames, IA (US)

(21) Appl. No.: 17/742,373

(22) Filed: May 11, 2022

Related U.S. Application Data
(60) Provisional application No. 63/186,995, filed on May 11, 2021.

(51) Int. Cl. B60W 50/06; B62D 15/02

(52) U.S. Cl. CPC B60W 50/06; B62D 15/025; B60W 2420/40; B60W 2420/52

(57) ABSTRACT

An automatic steering system for an agricultural vehicle includes an assisted steering device and a controller or estimator operatively coupled to the assisted steering device and configured to adjust a calibration range. Adjusting the calibration range includes generating an estimated curvature for the vehicle based on a pose of the agricultural vehicle; generating an estimated encoder position of the encoder based on the estimated curvature; determining a current encoder position of the encoder; and adjusting the calibrated encoder range based on the estimated encoder position and the current encoder position.

### CROSS-REFERENCE TO RELATED APPLICATION(S)

This application claims priority to U.S. Provisional Application No. 63/186,995 filed May 11, 2021, and entitled “Calibration Adjustment for Automatic Steering Systems,” which is hereby incorporated by reference in its entirety under 35 U.S.C. § 119(e).

### BACKGROUND

The disclosure generally relates to devices, systems, and methods for improving automatic steering systems and more particularly relates to calibrating automatic steering systems of agricultural vehicles.

Automatic steering systems are sometimes used to steer agricultural vehicles along a desired trajectory. During a typical operation, the automatic steering system adjusts the curvature of an agricultural vehicle to guide the vehicle from its current position to a new position along the desired trajectory. An agricultural vehicle's true curvature often refers to the true or actual angle of the vehicle's wheels while the vehicle's calibrated curvature refers to the vehicle's curvature as represented or set by the steering system.

As will be appreciated, the correlation between the calibrated vehicle curvature and the true vehicle curvature can shift over time. As an example, the correlation between the calibrated vehicle position as indicated by the position of a vehicle's steering wheel or the readout from a wheel-angle sensor and the true curvature corresponding to the orientation of the vehicle's wheels can shift over time. Such shifts in the correlation may be due to factors such as leaky hydraulics, poor calibrations, adverse driving conditions, and in some cases continuing to turn the steering wheel past the end stops or other reasons understood by those of skill in the art. A degrading correspondence between the calibrated vehicle curvature and the true vehicle curvature can lead to degraded performance by the steering system. There is thus a desire to improve or correct the correlation between the calibrated curvature and the true curvature when such shifts occur.

### BRIEF SUMMARY

Various devices, systems and methods related to automatic steering systems for agricultural vehicles are described herein. According to an aspect of the disclosure, an automatic steering system for an agricultural vehicle includes an assisted steering device and a controller or estimator operatively coupled to the assisted steering device. The assisted steering device is configured to mount to a steering wheel of an agricultural vehicle and includes a motor and an encoder comprising a calibration range. The controller or estimator is configured to adjust the calibration range. The adjusting includes generating an estimated curvature for the vehicle based on a pose of the agricultural vehicle; generating an estimated encoder position of the encoder based on the estimated curvature; determining a current encoder position of the encoder; and adjusting the calibrated encoder range based on the estimated encoder position and the current encoder position.

In various implementations the automatic steering system includes one or more features and/or additional aspects including, wherein the adjusting further comprises generating the pose of the agricultural vehicle based on at least one of geolocation data and IMU data; wherein generating the estimated encoder position comprises using a curvature-to-encoder transformation for the encoder; wherein the calibration range comprises a calibration range reference, and wherein the adjusting of the calibration range further comprises comparing the estimated encoder position and the current encoder position, generating an estimated range reference based on the calibration reference and the comparison of the estimated and current encoder positions, and adjusting the calibration range based on the estimated range reference and the calibration range reference.

In various implementations the automatic steering system includes one or more features and/or additional aspects including, wherein the calibration range reference comprises a maximum of the calibration range and the estimated range reference comprises a maximum of the estimated calibration range; wherein the adjusting of the calibration range further comprises filtering a plurality of values of the estimated range reference to generate a filtered estimated range reference, and adjusting the calibration range based on the calibration range reference and the filtered estimated range reference; wherein adjusting the calibration range comprises shifting the calibration range toward the estimated calibration range; wherein shifting the calibration range comprises shifting the calibration range in a plurality of steps; and wherein each of the plurality of steps comprises a shift of the calibration range toward the estimated calibration range by about 25% or less of the calibration range.

According to another aspect, an automatic steering system for a vehicle is provided. The automatic steering system includes an assisted steering device configured to mount to a steering wheel of a vehicle, the assisted steering device comprising a motor and an encoder comprising a calibrated encoder range comprising a calibrated range reference. The automatic steering system also includes a controller configured to adjust the calibrated encoder range, the adjusting comprising:
generating an estimated curvature for the vehicle based on sensor data;
generating an estimated encoder position based on the estimated curvature;
determining a current encoder position;
generating an estimated range reference based on the calibrated range reference and a comparison of the estimated encoder position and the current encoder position;
filtering a plurality of values of the estimated range reference to generate a filtered estimated range reference;
determining a difference between the calibrated range reference and the filtered estimated range reference; and
adjusting the calibrated encoder range based on the difference.

According to various implementations, the steering system includes one or more features and/or additional aspects including, wherein the sensor data comprises at least one of geolocation data and IMU data; wherein the sensor data is derived from one or more of GPS, accelerometers, gyroscopes, camera systems, radar and LIDAR; wherein the calibrated range reference comprises a maximum of the calibrated encoder range and the estimated range reference comprises a maximum of the estimated encoder range, wherein adjusting the calibrated encoder range comprises shifting the calibrated encoder range toward the estimated encoder range; wherein shifting the calibrated encoder range comprises shifting the calibrated encoder range in a plurality of steps over a period of time and wherein each of the plurality of steps comprises a shift of the calibrated encoder range toward the estimated encoder range by about 25% or less of the calibrated encoder range.

Another aspect of the disclosure provides a method for adjusting the calibration of an automatic steering system of an agricultural vehicle. The method comprises:
generating an estimated curvature of an agricultural vehicle based on sensor data, the agricultural vehicle comprising an automatic steering system comprising a steering sensor comprising a calibration range comprising a calibration range reference;
generating, with a controller or an estimator, an estimated steering position of the agricultural vehicle based on the estimated curvature;
determining a current steering position of the agricultural vehicle;
comparing, with the controller or the estimator, the estimated steering position and the current steering position;
generating, with the controller or the estimator, an estimated range reference based on the calibration range reference and the comparison of the estimated and current steering positions;
filtering, with the controller or the estimator, a plurality of values of the estimated range reference to generate a filtered estimated range reference; and
adjusting the calibration range based on the calibration range reference and the filtered estimated range reference.

According to various implementations, the method includes one or more features and/or additional aspects including wherein the sensor data comprises at least one of geolocation data and IMU data; wherein the calibration range reference comprises a maximum of the calibration range and the estimated range reference comprises a maximum of the estimated range, and wherein adjusting the calibration range comprises shifting the calibration range toward the estimated range in a plurality of steps.

While multiple embodiments are disclosed, still other embodiments of the disclosure will become apparent to those skilled in the art from the following detailed description, which shows and describes illustrative embodiments of the disclosed apparatus, systems and methods. As will be realized, the disclosed apparatus, systems and methods are capable of modifications in various obvious aspects, all without departing from the spirit and scope of the disclosure. Accordingly, the drawings and detailed description are to be regarded as illustrative in nature and not restrictive.

### BRIEF DESCRIPTION OF THE DRAWINGS

FIG. 1 is a schematic view of an automatic steering system for an agricultural vehicle according to an implementation.

FIGS. 2-4 are schematic views of automatic steering systems for an agricultural vehicle according to various implementations.

FIG. 5 is a perspective view of a wheel angle sensor kit according to an implementation.

FIG. 6 is a flow diagram illustrating a method for adjusting the calibration of an automatic steering system according to an implementation.

FIG. 7 is a perspective view of an automatic steering system mounted to a steering wheel of an agricultural vehicle according to an implementation.

FIG. 8 is a system diagram of an automatic steering system according to an implementation.

FIG. 9 is a flow diagram illustrating a method for adjusting the calibration of an automatic steering system according to an implementation.

FIG. 10 is a flow diagram illustrating a method for adjusting the calibration of an automatic steering system according to an implementation.

### DETAILED DESCRIPTION

The various embodiments disclosed and contemplated herein relate to the calibration of automatic steering systems for agricultural vehicles. More specifically, various implementations of the disclosed embodiments provide devices, systems and methods for adjusting or correcting the steering system's calibration. Adjustments to the steering calibration can improve the correlation between the calibrated vehicle curvature and the vehicle's true curvature, thus improving the steering performance of the vehicle.

According to one aspect of the disclosure, various implementations of an automatic steering system are configured to generate and use an estimate of the actual (i.e., true) vehicle curvature to identify and adjust for errors in the system's steering calibration. For example, in some cases the automatic steering system computes an estimated curvature of the vehicle using the vehicle's heading rate and velocity. In some implementations the steering system generates the estimated curvature using an estimate of the vehicle heading rate and velocity, such as an estimate based on geolocation, acceleration, and orientation data and the like. The steering system then determines any difference between the estimated curvature and a calibrated vehicle curvature indicated by, for example, the vehicle's steering position or steering angle. The difference between the estimated vehicle curvature and the calibrated vehicle curvature is then used by the system to adjust the steering calibration.

Using an estimate of the actual vehicle curvature to adjust the steering calibration as disclosed herein can in some cases provide various benefits when compared with existing calibration adjustment techniques. As one example, implementations of the disclosed technology can result in quick and accurate estimates of the true vehicle curvature without the need for a highly accurate, yet costly, external steering sensor. In addition, various implementations enable a quicker calibration initialization because, for example, the correlation error can be adjusted for over time and thus the initial calibration estimate can be less precise than might otherwise be needed.

As used herein, an agricultural vehicle's true curvature may also be referred to herein as the “true vehicle curvature” or the “actual vehicle curvature.” The term “calibrated vehicle curvature” is used herein to refer to the vehicle curvature currently indicated, measured, reported, or otherwise represented by the agricultural vehicle's steering system. In some cases the calibrated vehicle curvature may also be referred to herein as the “current vehicle curvature” or the “reported vehicle curvature.”

According to various implementations, the calibrated vehicle curvature may be characterized as a steering angle or steering position. In various implementations an automatic steering system determines the calibrated vehicle curvature from one or more steering feedback signals generated by one or more steering sensors. As an example, in some cases the calibrated vehicle curvature is determined based on the measured or reported position of the vehicle's steering wheel. As another example, in some cases the calibrated vehicle curvature is determined based on the vehicle's wheel angle, as sensed or measured and reported by a wheel angle sensor or another steering sensor.

Implementations of the disclosed technology may use additional examples of a steering feedback signal. In some cases a steering encoder or another sensor that is part of an assisted steering system may generate a steering feedback signal indicating, for example, the current or measured steering position. In some cases one or more feedback signals are received from a steering sensor through a Controller Area Network (CAN) bus or another vehicle network. For example, a vehicle steering sensor may generate and transmit a feedback signal to the CAN bus that includes a steering wheel or vehicle wheel position and/or turning rate. In some cases an automated steering system may receive one or more feedback signals from a wheel angle sensor that provides a wheel angle position or rate. In some cases a factory installed or aftermarket wheel angle sensor generates a steering feedback signal that can be used by an automatic steering system to control, for example, an integrated valve steering mechanism. As another example, in some cases a vehicle's steering wheel may be equipped with one or more rotational sensors that generate feedback signals based on the wheel's rotational position and/or rate of turning. Other sources for feedback about the currently calibrated steering angle or position are also possible.

According to another aspect, in various implementations the steering system corrects errors in the steering calibration by adjusting a calibration range of the steering system, such as the calibration range of a steering position sensor (e.g., a steering wheel encoder, wheel angle sensor, etc.). As an example, in various implementations the steering system determines an estimated reference value for the steering sensor calibration range based on a reference value of the current calibration range and the difference between the estimated vehicle curvature and the calibrated vehicle curvature. The system then shifts the calibrated sensor range to reduce any difference between the estimated reference value and the calibration range reference value. In various implementations the estimated reference value and the current calibrated range reference value are corresponding maximums, minimums, or some other value of the respective estimated sensor range and current, calibrated sensor range. To reduce the effect of signal noise, in some cases the system filters (e.g., with a moving average) multiple calculations of the estimated range reference (e.g., maximum) over a period of time.

While certain implementations discussed herein relate to a calibration range reference value that is a maximum, it is readily appreciated that in further versions any defined calibration range value, such as a sensor calibration range minimum, center, or any other defined reference point within the range can be used. That is, in certain implementations, the calibration range maximum can be substituted with any defined reference point as a defined calibration range value, as would be appreciated by those of skill in the art.

In various implementations, the steering position sensor may be one of a variety of sensors for measuring and determining the current vehicle steering position or angle, also referred to herein as the calibrated vehicle curvature. As an example, in some implementations the steering sensor is a steering wheel encoder that indicates the position of the agricultural vehicle's steering wheel.

Another part of the disclosure describes how the automatic steering system in various implementations compares the vehicle's estimated curvature and calibrated curvature by comparing corresponding steering positions. In some cases, for example, the calibrated vehicle curvature is approximated by determining (e.g., measuring) the current steering position. Further, the steering system in such cases uses a curvature-to-steering position transformation, such as a standard linear interpolation, to generate an estimated steering position based on the estimated vehicle curvature. Once both steering positions are available, the steering system determines any differences between the measured steering position (i.e., according to the current calibration) and the estimated steering position.

The agricultural vehicle's current steering position may be determined in a number of ways. According to various implementations, the automatic steering system compares corresponding steering positions by comparing corresponding steering wheel encoder positions. In some cases, for example, the calibrated vehicle curvature is approximated by determining (e.g., measuring) the current position of the steering encoder. Further, the steering system in such cases uses a curvature-to-encoder transformation, such as a standard linear interpolation, to generate an estimated encoder position based on the estimated vehicle curvature. Once both encoder positions are available, the steering system determines any differences between the measured encoder position (i.e., according to the current calibration) and the estimated position.

According to another aspect of the disclosure, in various implementations the automatic steering system shifts the range of calibration over a period of time so that the calibration range reference value (e.g., maximum) is closer to, or the same as, the estimated/calculated reference value (e.g., maximum). For example, in some cases the system increases the calibration range reference value toward the calculated calibration reference value in a series of incremental steps over a period of time. The difference between calibrated and true calibration range thus decreases with each incremental increase, providing a burning down or reduction of the calibration error instead of a one-time correction. In some cases, the relatively gradual adjustment enables a quicker initialization since the initial estimate can be less precise.

In various implementations the calibration range reflects the calibration range of a steering wheel encoder, though other steering sensors (e.g., a wheel angle sensor) may also be used. In such an example, the automatic steering system shifts the range of the encoder over a period of time so that the calibrated encoder reference value (e.g., maximum) is closer to, or the same as, the estimated/calculated reference value (e.g., maximum). For example, in some cases the system increases the encoder range reference value toward the calculated encoder reference value in a series of incremental steps over a period of time. The difference between calibrated and true encoder range thus decreases with each incremental increase, providing a burning down or reduction of the calibration error instead of a one-time correction.

According to various implementations, an automatic steering system includes a state observer and/or state estimator configured to determine (e.g., estimate) the actual vehicle curvature based on one or more sensor inputs and/or steering information. As will be appreciated, in control theory a state observer or state estimator (also called an observer or an estimator) is a system that provides an estimate of the internal state of another second system from measurements of the inputs and outputs of that other system. According to various implementations, an estimator is configured to estimate the actual vehicle curvature of an agricultural vehicle based on various inputs including, for example, geolocation data and/or vehicle movement data.

In various cases an estimator may be implemented with one or more processing and computing components such as, for example, a CPU or processor, data storage, and computer-readable instructions that configure the processor or CPU to carry out the operations of the estimator. In some cases the estimator may be incorporated into a steering controller or another component of the automatic steering system. In various cases the steering controller and the estimator may be implemented as a hybridized system such as a Linear-quadratic-Gaussian (LQG) control. In some cases the estimator may be implemented with shared computing components that also provide the functionality of, e.g., the steering controller, a display unit, or another component. In various cases the estimator may be implemented by separate and/or remote computing components, such as network and/or cloud-based computer components.

For simplicity and ease of reference herein, when the steering system is described as performing one or more process steps and/or providing one or more features of the automatic steering system, it should be assumed that one or more of a steering controller, estimator and/or another computing component of the system performs the steps and/or provides the relevant features unless otherwise indicated. Accordingly, in some cases relevant operations of the system such as, for example, estimating vehicle curvature, steering positions, and the like described as being determined by the steering system may be determined by the controller, estimator, or another computing component of the automatic steering system or another system.

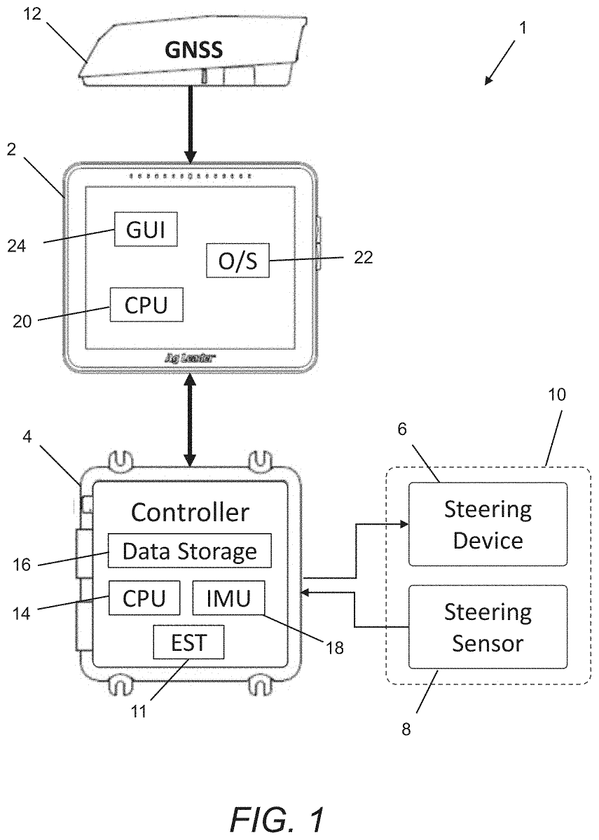

Turning to the drawings, FIG. 1 is a schematic view of an automatic steering system 1 for an agricultural vehicle according to various implementations. As depicted in this particular example, the automatic steering system 1 includes a display unit 2 in communication with a steering controller 4. The steering controller 4 is coupled in communication with a vehicle steering device 6 and a vehicle steering sensor 8. According to various implementations the steering device 6 and the steering sensor 8 are part of an integrated steering mechanism 10. In the implementation shown in FIG. 1, an estimator 11 is provided as part of the steering controller 4. In some cases the estimator 11 is configured to estimate the actual vehicle curvature based on geolocation and/or vehicle movement data. In various implementations, the automatic steering system 1 is also operationally integrated with a GNSS or GPS unit 12, such as a GPS 7500, such that the system 1 is configured to input positional data for use in defining boundaries, locating the vehicle, plotting guidance, and the like, as will be readily appreciated. As an example, in some cases the controller 4 (e.g., the controller itself and/or the estimator 11 and/or another component of the controller) is configured to determine (e.g., estimate) the current position and/or trajectory of the vehicle using data from the GNSS/GPS unit 12.

According to various implementations, the controller 4 includes one or more processing and computing components for implementing various technologies disclosed herein and elsewhere. As shown in FIG. 1, some of the components of the controller 4 can include a CPU or processor 14, data storage 16, and an optional inertial measurement unit (IMU) 18. In the depicted implementation the controller 4 also includes the state estimator 11. The estimator 11, the CPU 14, data storage 16, IMU 18, and/or other components of the controller may process input data and enable the various features and process steps described with respect to various implementations of automatic steering systems described herein.

The controller 4 is communicatively coupled with the display 2. In some cases the display 2 includes its own processing and computing component(s), such as a CPU or other processor 20, which runs an operating system 22 that provides a graphical user interface (GUI) 24. According to various implementations, the estimator 11 may instead be provided as part of the display 2. One example of a display unit is the display unit sold under the name InCommand® by Ag Leader Technology of Ames, Iowa. It is appreciated that the display 2 may include a touchscreen and/or be equipped with interface components such as a keyboard, mouse, and/or other device for interacting with the system 1.

It should be appreciated that the controller 4 and/or estimator 11 may be located in one of many places according to various implementations. For example, in some cases the controller and/or estimator is a discrete physical component mounted separately from other components. In some cases the controller and/or estimator is mounted within and/or is integral to another component, such as the display unit 2, the steering mechanism 10, or another component. In the depicted example the display 2 is provided separately from the controller 4. It should be appreciated that the various components of the display 2, the controller 4, and the estimator 11 are in operational communication with one another as needed via wired or wireless connections and are configured to perform processes and execute commands to implement operations and features described herein.

According to various implementations, the controller 4 and/or estimator 11 is configured to determine a desired trajectory and the controller 4 is configured to control the steering device 6 to steer the vehicle along the desired trajectory. As an example, in some cases the estimator and/or controller is configured to determine a vehicle curvature that will guide the vehicle from its current position to a new position along the desired trajectory. In various implementations the controller and/or estimator determines the vehicle curvature as a desired steering angle or position of the vehicle wheel(s) and/or steering wheel. The controller and/or estimator is configured to then determine a turning rate (e.g., in terms of speed and direction) to bring the steering wheel or vehicle wheel(s) from its current position to the desired position within a particular amount of time. It is appreciated that in various implementations, one or more controller, estimator, and/or other control circuitry is provided.

In various implementations the system 1 also includes a communications component (not shown) configured for sending and receiving data to one or more cloud-based locations for processing and storage. As examples, data may be transmitted to and from a remote server, database, and/or other cloud computing components readily understood in the art. Such connections by the communications component can be made wirelessly via understood internet and/or cellular technologies such as Bluetooth, Wi-Fi, LTE, 3G, 4G, or 5G connections and the like. It is understood that in certain implementations, the communications component and/or cloud components comprise encryption or other data privacy components such as hardware, software, and/or firmware security aspects. In various implementations, the operator or enterprise manager or other third parties are able to receive notifications such as adjustment prompts and confirmation screens on their mobile devices, and in certain implementations can review the plotted guidance paths and make adjustments via their mobile phones.

As depicted in the example of FIG. 1, in some cases the steering device 6 and the steering sensor 8 are part of an integrated steering mechanism 10. For example, the integrated steering mechanism 10 can in some cases be an assisted steering device that includes a motor drive unit (MDU) with a drive motor configured to rotate the vehicle's steering wheel in response to commands from the controller. In such a case, the steering sensor 8 is provided by a motor encoder that senses rotation of the motor using, for example, a Hall-effect sensor. The MDU generates and sends a feedback signal to the controller 4 and/or estimator 11 based on the sensor output.

According to various implementations, the steering device 6 may be a hydraulic valve that is part of an integrated hydraulic steering system. As another example, in some cases the steering device 6 may be an OEM or factory-installed steering control system (e.g., including a hydraulic, electric, electrohydraulic, or another type of steering device) that is controllable through a Controller Area Network (CAN) bus or another vehicle network. In such examples, the steering sensor 8 may be provided as part of an integrated steering system or an OEM steering control system or may be provided separately as a dealer or aftermarket installed sensor.

According to various implementations, the steering sensor 8 may be one of various types of sensors suitable for generating one or more feedback signals conveying steering information including, for example, information representing a current steering position or steering angle. As noted above, in some cases the steering sensor 8 is provided by a motor encoder. In various cases the steering sensor 8 is a factory installed or aftermarket wheel angle sensor that generates a steering feedback signal. As another example, in some cases a vehicle's steering wheel may be equipped with one or more rotational sensors that generate feedback signals based on the wheel's rotational position and/or rate of turning. In some cases the steering sensor 8 may include a strain gauge that changes resistance as it bends, Measuring the resistance enables determination of the amount of bend in the sensor, which can enable measuring an angle of a wheel relative to a vehicle when attached to a wheel linkage. Such a measurement could also provide the position of the wheel (also called the vehicle's wheel angle). In various other cases, the steering sensor 8 may be a pressure sensor. For example, the sensor may measure the changing pressure in a valve attached between the wheel and the vehicle. Turning the wheel changes the wheel angle, which in turn changes the valve pressure, which can be sensed and sent to the controller as a feedback signal. Of course other types of steering sensors are possible and implementations of the disclosed technology are not limited to any one type of steering sensor.

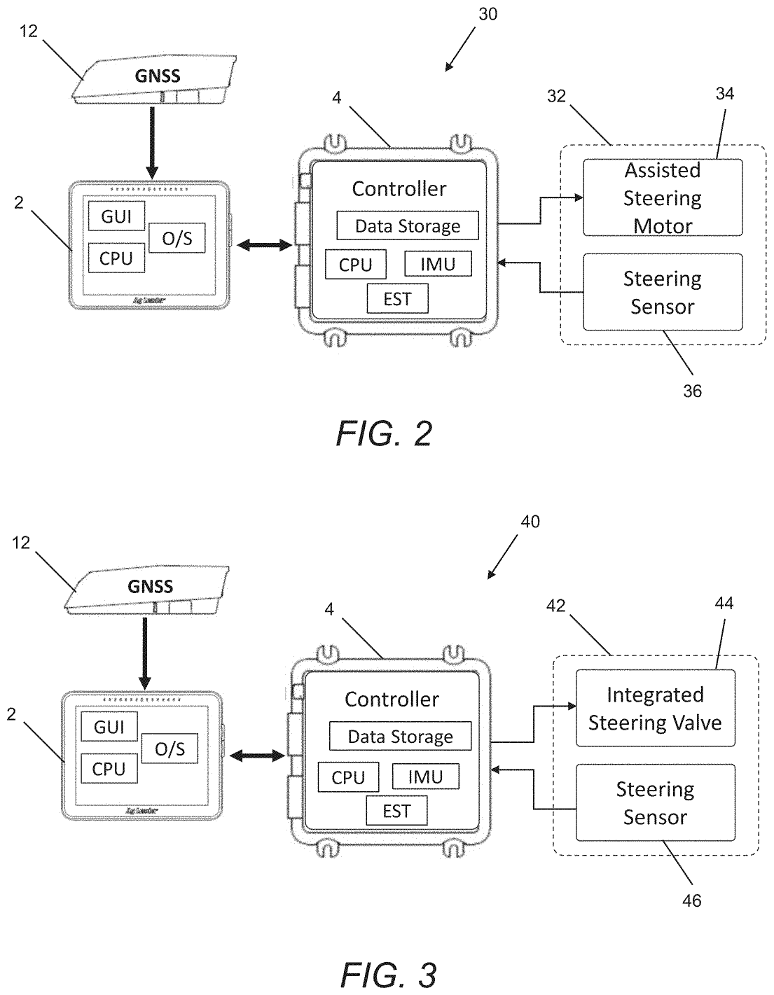

FIGS. 2-4 are schematic views of various automatic steering systems for an agricultural vehicle according to various implementations. The steering systems include several components in common with the system 1 shown in FIG. 1, but in each case include a differing type of automated steering device. FIG. 2 illustrates an example of an automatic steering system 30 that includes an assisted steering device 32 in communication with the steering controller 4 and estimator. The assisted steering device 32 includes a steering motor 34 and a steering sensor 36. One example of an assisted steering device is a motorized system that attaches directly to a vehicle's steering wheel. The system's motor simulates a human physically turning the steering wheel to turn the vehicle's wheels. In some cases the steering sensor 36 is provided by a motor encoder that senses rotation of the steering motor 34 using, for example, a Hall-effect sensor. As shown in FIG. 2, the steering motor 34 and steering sensor 36 are in some cases provided as part of an integrated assisted steering device 32. It should be appreciated that in various implementations the steering motor and steering sensor may be provided separately as well.

FIG. 3 illustrates a schematic diagram of another automatic steering system 40 that includes a steering mechanism 42 with an integrated steering valve 44 according to various implementations. As an example, in some cases the steering valve 44 is a hydraulic valve that attaches directly to the vehicle's wheels or steering linkage. The controller 4 is configured to send the valve 44 a command that actuates the valve, thus pushing on the vehicle's wheel and causing it to turn. In various cases the integrated steering valve is built into an agricultural vehicle, such as a tractor and movement of the valve does not result in the steering wheel turning in the cab. In some cases an agricultural vehicle may be equipped with a steering valve at the factory, while in some cases an aftermarket valve may be installed. The steering mechanism 42 also includes a steering sensor 46, which in some cases is housed and mounted to the vehicle separately from the steering valve 44. In some cases the steering sensor 46 may be implemented by one of the sensors described herein, or by any other sensor of suitable design.

FIG. 4 illustrates a schematic diagram of another automatic steering system 50 that includes a steering mechanism 52 with an OEM or factory-installed steering control 54 (e.g., including a hydraulic, electric, electrohydraulic, or another type of steering device) that is controllable through a Controller Area Network (CAN) bus or another vehicle network. The steering mechanism 52 also includes a steering sensor 56, which in some cases is housed and mounted to the vehicle separately from the steering control 54. In some cases the steering sensor 56 may be implemented by one of the sensors described herein, or by any other sensor of suitable design.

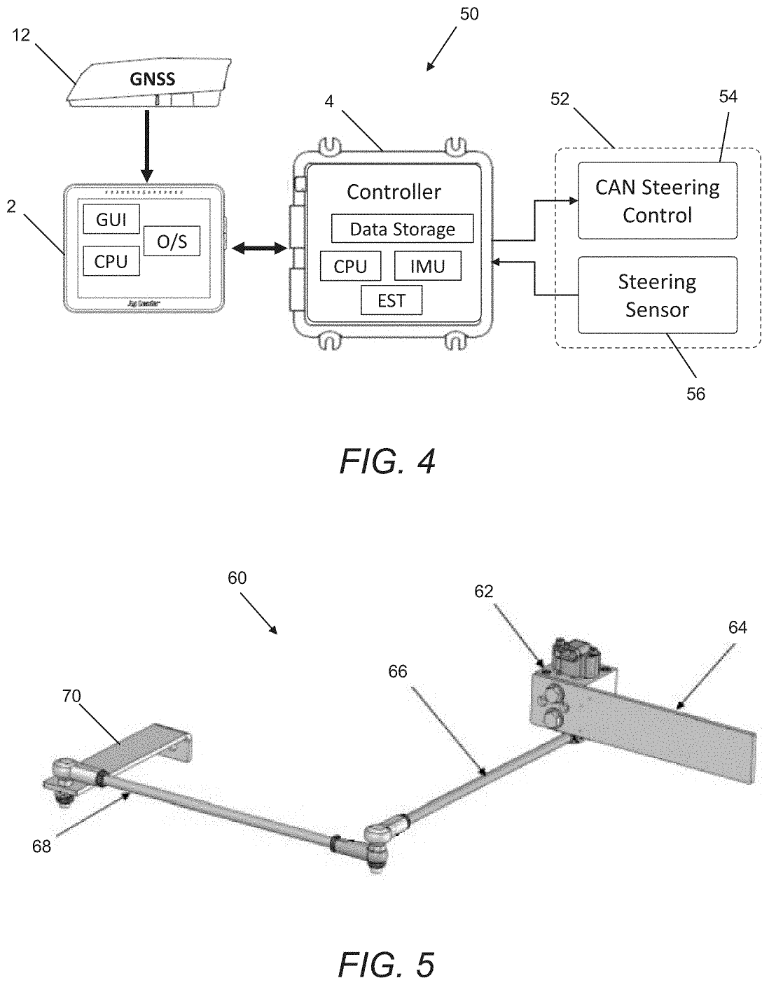

Turning to FIG. 5, a perspective view of a wheel angle sensor kit 60 is depicted according to various implementations. The kit 60 generally includes a wheel angle sensor assembly 62 mounted to a sensor bracket 64 for coupling the sensor to a stational point on an agricultural vehicle, such as a fixed point on the chassis or axle housing. A linkage arm 66 and a linkage rod 68 couple to the sensor assembly 62 to a linkage rod bracket 70, which can be mounted to a moving part of the steering system, such as a wheel support or steering linkage. As the vehicle's wheel turns, the interconnected linkages actuate the sensor assembly 62, thus generating a feedback signal corresponding to the wheel's steering position and/or turning rate.

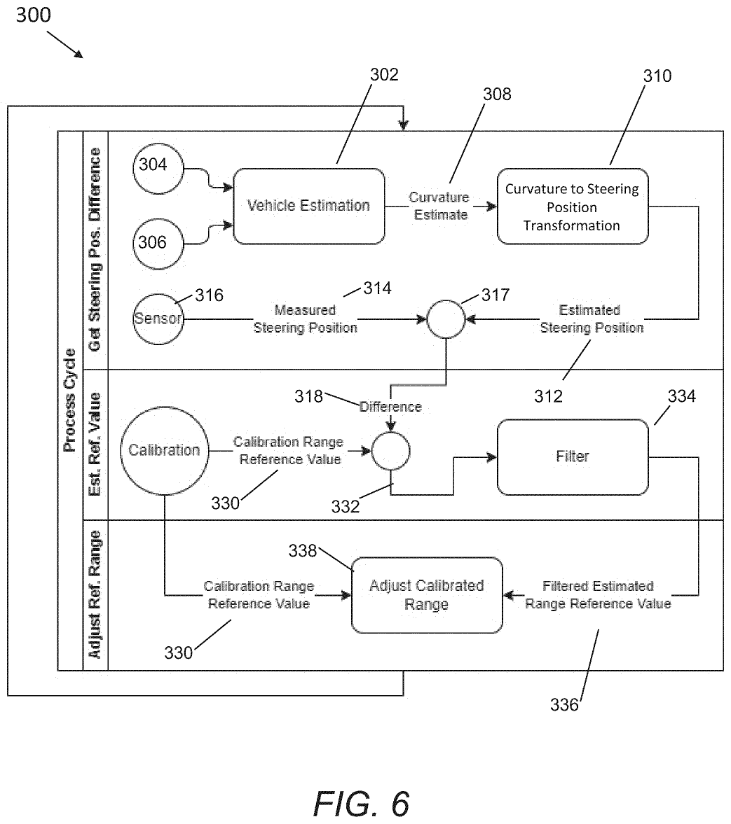

FIG. 6 is a flow diagram illustrating a method 300 for adjusting the calibration of an automatic steering system according to various implementations. In the method as shown in this example, the automatic steering system (e.g., via a controller, estimator, and/or other computing circuitry) estimates the actual curvature of the vehicle's trajectory and then uses the estimate to adjust the calibration of the vehicle's steering sensor. Estimating the vehicle's curvature enables the steering system to evaluate and correct the steering calibration without needing to measure or determine the actual curvature exhibited by the vehicle. Accordingly, the steering system can adjust the steering calibration without an external encoder, wheel angle sensor, or other technique normally needed for measuring the actual curvature.

A first part of the method 300 involves determining whether any difference exists between the current, calibrated vehicle curvature and an estimate of the actual curvature of the vehicle. As shown in FIG. 6, in some implementations the method 300 determines the curvature difference by comparing corresponding steering positions. For example, in some cases the steering system may compare steering positions corresponding to a steering wheel encoder, a wheel angle sensor, or any other suitable steering sensor.

In various implementations a steering system generates an estimate of the actual vehicle curvature using sensor data that includes positional data and/or data from onboard sensors. In the example in FIG. 6, the steering system receives positional data from a geolocation data source 304, such as a GPS source. The system also receives vehicle movement data 306, such as acceleration and orientation measurements from an onboard inertial measurement unit (IMU). According to various implementations, the steering system uses the positional data and vehicle movement data as inputs for a Kalman filter analysis. The system conducts the filter analysis to generate a vehicle pose, which is shown in FIG. 6 as a “vehicle estimation” 302. According to various implementations, the estimated vehicle curvature (e.g., vehicle estimation 302) is conducted by an estimator, such as the estimator 11 shown in FIGS. 1-4. Other types of analyses can similarly be used to generate a vehicle pose.

According to various implementations, vehicle heading and vehicle velocity are two parts of the vehicle pose output by the filter analysis. The first derivative of the heading, known as the heading rate or yaw rate, is then used with the vehicle velocity, v, to determine the estimated curvature 308 of the vehicle according to the following relationship:

$${κ}_{est} = \frac{\dot{ψ}}{v}$$

in which \dot{ψ} represents the heading rate (also referred to as heading rate-of-change or yaw rate), ν represents the vehicle's velocity, and κₑₛₜ represents the estimated curvature 308.

Before comparing the estimated curvature 308 to the calibrated curvature currently indicated by the steering sensor, the steering system performs a transformation 310 to generate an estimated steering position 312. The estimated steering position 312 represents, for example, a physical orientation of the steering system and/or expected response from a steering sensor that would result in the estimated curvature 308. As shown in FIG. 6, the system utilizes a calibrated curvature-to-steering position transformation 310 to generate the estimated steering position 312. The computation of the estimated steering position 312 can in some cases be represented as:

SteerPosₑₛₜ=ComputeSteer(κₑₛₜ)

in which ComputeSteer(κₑₛₜ) represents the curvature-to-steering position transformation 310.

The curvature-to-steering position transformation 310 can be accomplished using a number of suitable linear and/or nonlinear conversions. According to various implementations, the transformation 310 is determined according to the following linear transformation:

$${SteerPos}_{est} = ( {SteerPos}_{max} - {SteerPos}_{min} ) \times \frac{( {κ}_{est} - {κ}_{min} )}{( {κ}_{max} - {κ}_{min} )} + {SteerPos}_{min}$$

in which SteerPosₘₐₓ and SteerPosₘᵢₙ are the maximum and minimum steering positions (e.g., corresponding to maximum/minimum values of the steering sensor), respectively, and κₘₐₓ and κₘᵢₙ are the maximum and minimum curvatures, respectively, achievable by the steering system. In some cases the estimated steering position 312 is determined as a number of sensor counts or range subdivisions.

Returning to FIG. 6, the steering system also receives a measurement of the current steering position 314 from the steering sensor (e.g., a wheel encoder, wheel angle sensor, etc.). As used herein, this measurement is also referred to as a current steering position, SteerPos_{cur}. For example, in various cases involving a steering assist motor and encoder, a Hall-effect sensor that measures the position (e.g., current rotation) of the motor and encoder as a number of encoder counts.

Once both the estimated steering position 312 and the current steering position 314 are determined, the steering system (e.g., the controller and/or estimator) then compares 317 the positions to determine a difference 318 in steering positions:

diff=SteerPos_{cur}−SteerPosₑₛₜ

The difference 318 between the steering positions may be determined as a number of steering units, which may vary depending upon the type of steering sensor being used. As just one example, in various cases involving a steering wheel encoder, the difference is measured as a number of encoder counts. As previously noted, the difference 318 between the current and estimated steering positions also represents the difference between the estimated vehicle curvature 308 and the calibrated vehicle curvature.

According to various implementations, the steering system corrects the steering calibration by adjusting the steering system's calibration range. This may include, for example, shifting the range of a steering sensor to more closely correspond to an estimated calibration range. The method 300, shown in the example of FIG. 6, includes determining a reference value 330 for the calibration range. The system uses this reference 330 of the calibration range, CalRange_Ref_{cal}, and the difference 318 between the current and estimated steering positions to generate an estimated range reference value 332, CalRange_Refₑₛₜ, of the steering encoder:

CalRange_Refₑₛₜ=CalRange_Ref_{cal}+diff

According to some implementations, the estimated range reference 332 is processed by a filter 334 such as a Kalman filter to provide a filtered estimated range reference 336, CalRange_Ref_{filtered}. In some cases, filtering in this manner can reduce the effects of noise on the computed value. Certain implementations can make use of a rolling average. As an example, in some cases the steering system computes an average of multiple values of the estimated range reference value to improve the accuracy of the estimate:

$${CalRange\_Ref}_{filtered} = \frac{1}{b - a} {\sum }_{a}^{b} {CalRange\_Ref}_{est}$$

wherein a and b represent the first and last values collected over a period of time. While one example of a filter is discussed, it should be appreciated that implementations that filter the estimated encoder range value are not limited to any specific filter. Other types of data conditioning or filtering that may be used include, but are not limited to, a rolling buffer, a first, second, or n^{th} order filter, a Kalman filter (e.g., such as the above example), and a linear-least squares filter.

After generating and filtering the estimated range reference, the method 300 includes adjusting or shifting 338 the calibration range to more closely match the estimated calibration range. Prior to the adjustment, the method includes determining the difference between the estimated range reference and the calibrated range reference. In various implementations the difference is represented as a number of sensor values or counts corresponding to the range of possible steering positions.

Assuming the calibrated range reference is different from the estimated range reference, the steering system adjusts 338 the calibrated range reference to be closer to, or the same as, the estimated range reference. In various implementations aligning the calibration range reference with the estimated range reference provides a simple and straightforward way to align the full range of calibration values. As an example, for a range of [−1500, CalRange_Ref_{cal}, 1500], shifting the calibration range reference from CalRange_Ref_{cal} to CalRange_Ref_{cal}+1500 also shifts the range minimum, range maximum, and all points in between, resulting in a shifted range of [0, CalRange_Ref_{cal}+1500, 3000].

In various cases the system dynamically shifts the entire calibration range up or down so that the calibration range reference value is closer to the estimated range reference value. In some cases the system shifts the calibration range so that the calibration range reference value is the same as the estimated range reference value.

In some implementations, the steering system shifts the calibration range toward the estimated range in a single, one-time adjustment. In various implementations, though, the system shifts the calibration range in a series of incremental steps over a period of time. For example, in some cases each incremental shift is limited to about 25% or less of the total calibration range per step. In some cases each incremental shift is limited to about 1% (e.g., 0.5-1.5%) of the total calibration range per step. Other values are also possible.

The shifts may occur at any suitable frequency. In some cases the incremental shifts occur at an operating frequency of the automatic steering system. In some cases the operating frequency is based on the period of communication between a steering driver or device and the steering system controller. As an example, in various implementations the calibration shifts occur at a rate of 50 Hz. In some cases the step size and/or update frequency is designed to limit degradation of an operator's experience while using the system. In some cases successive iterations of the method 300 at 50 Hz may correct a misalignment of the calibration range in 5 seconds or less depending upon the degree of initial misalignment. In some cases the correction may occur within 3 seconds or less at 50 Hz.

In various implementations, such short correction times can also provide a feasible way to repeatedly initialize a steering system's calibration. Such capability can be useful when a steering system's calibration needs to be initialized after every system power cycle. As an example, some implementations of an automatic steering system may not retain calibration information or instantly and automatically determine such information upon power up. In such cases, each power up of the system reports back an initial steering position value of zero.

One type of initial calibration procedure that can be used in some cases is a manual procedure that takes time and is error-prone. Such a procedure involves the operator moving the steering-wheel from full right to full left (e.g., from end-stop to end-stop or between points in which the wheels stop turning). Monitoring steering position values during the movement provides a size and maximum value of the calibration range. However, if the operator did not perfectly center the steering wheel before beginning the initial calibration, the true wheel angle will not match the calibrated expectation. In such a case, for example, the steering wheel might be turned 10° to the right but the steering sensor reports a steering position of 0, which normally corresponds to the center of the expected range.

In this type of situation, implementations of the disclosed calibration method could initialize the calibration by estimating the vehicle curvature based on, for example, GPS and inertial movement measurements and then adjusting the calibration range to match the estimated curvature. While this initial calibration may in some cases be off by several degrees, successive iterations can quickly reduce the error within an acceptable time frame. For example, in some cases an initialization of this type can occur as quickly (e.g., within about 3 seconds of movement) as an automatic steering system takes to generate an initial vehicle pose.

Accordingly, this type of calibration initialization can be especially helpful when the automatic steering system needs to be frequently reinitialized. This can happen, for example, when the steering system lacks a steering sensor or other means that provides such calibration information upon power-up (e.g., a voltage-based wheel angle sensor, a pressure sensor, an absolute encoder, etc.). In various implementations an automatic steering system according to the disclosed technology may lack this type of initial calibration information, and thus quickly calibrating the steering system through successive iterations as disclosed above can be a useful feature. It should be appreciated that various implementations of an automatic steering system and/or methods of steering may utilize such a capability. For example, in some cases an automatic steering system includes or otherwise uses an absolute encoder or other sensor that inherently provides initial calibration information, thus removing the need to reinitialize after every power cycle, as would be appreciated.

As noted elsewhere herein, in various implementations the calibration range reference value and the estimated range reference value can be any suitable corresponding values in the calibration range and estimated range, respectively. In some cases the calibrated range reference and estimated range reference may each refer to a minimum, a center, a maximum, or any other desirable point within the respective ranges.

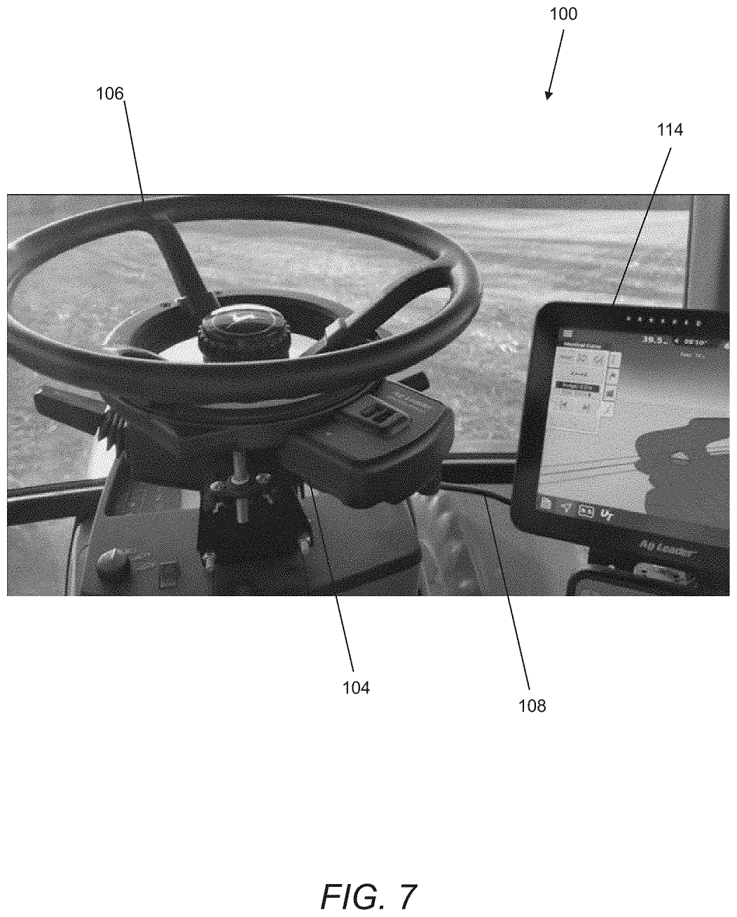

FIG. 7 is a perspective view of an automatic steering system 100 mounted within a vehicle according to various implementations. As depicted in this particular example, the automatic steering system 100 includes a display unit 114 and an assisted steering device 104 mounted to the steering wheel 106 of the vehicle. A communications link 108 connects the assisted steering device 104 to the display unit 114 and a controller housed within the display unit. According to various implementations, the controller includes an estimator or an estimator is provided as a separate component or as part of another component. It should be appreciated that the controller and estimator may be located in one of many places according to various implementations. For example, in some cases the controller and/or estimator is a discrete physical component mounted separately from other components. In some cases the controller and/or estimator is mounted within and/or is integral to another component, such as the display unit 114, the assisted steering device 104, or another component.

According to various implementations, the controller (not shown in FIG. 7) is configured to determine a desired trajectory and control the assisted steering device 104 to steer the vehicle along the desired trajectory. As an example, in some cases the controller and/or estimator is configured to determine a vehicle curvature that will guide the vehicle from its current position to a new position along the desired trajectory. In various implementations the controller and/or estimator determines the vehicle curvature as a desired steering angle or steering wheel position. The controller/estimator is configured to then determine a turning rate (e.g., in terms of speed and direction) to bring the steering wheel from its current position to the desired position within a particular amount of time.

According to various implementations, the assisted steering device 104 includes a motor drive unit (MDU) with a drive motor configured to rotate the steering wheel in response to commands from the controller. The MDU also includes a motor encoder that senses rotation of the motor using, for example, a Hall-effect sensor. The MDU generates and sends a feedback signal to the controller based on the sensor output. In various implementations the feedback signal includes the current encoder position and the current encoder rate. According to such implementations, the current encoder position corresponds to the current position of the motor and steering wheel and the current encoder rate corresponds to the speed and direction of the motor/steering wheel. In various implementations the controller also sends steering commands to the MDU in the form of desired encoder positions and/or rates. For example, in various cases the controller sends a desired encoder rate to the MDU to bring the encoder and the steering wheel from their current positions to new desired positions corresponding to a desired vehicle curvature.

In some cases, the current encoder rate is determined as a number of encoder counts per second. According to various implementations, the encoder has approximately 850 counts for one revolution of the steering wheel. In some such cases, the controller directs the MDU to adjust steering at up to a maximum rate of +/−1.5 revolutions (i.e., 1275 counts) per second, with the sign indicating whether to turn clockwise or counterclockwise.

In some cases, the MDU may include additional features, characteristics, and capabilities known in the art. In various implementations the assisted steering device 104 is similar to or the same as one or more of the steering devices disclosed in U.S. application Ser. No. 17/323,649, entitled “Assisted Steering Apparatus and Associated Systems and Methods,” and filed May 18, 2021, the entire content of which is hereby incorporated herein by reference. Those skilled in the art will further understand various methods and techniques for determining a desired trajectory and corrective steering angle. In some cases the controller may implement one or more techniques as taught in U.S. Publ. No. 2021/000341, entitled “Apparatus, Systems and Methods for Automatic Steering Guidance and Visualization of Guidance Paths,” and filed Jul. 6, 2020, the entire content of which is hereby incorporated herein by reference.

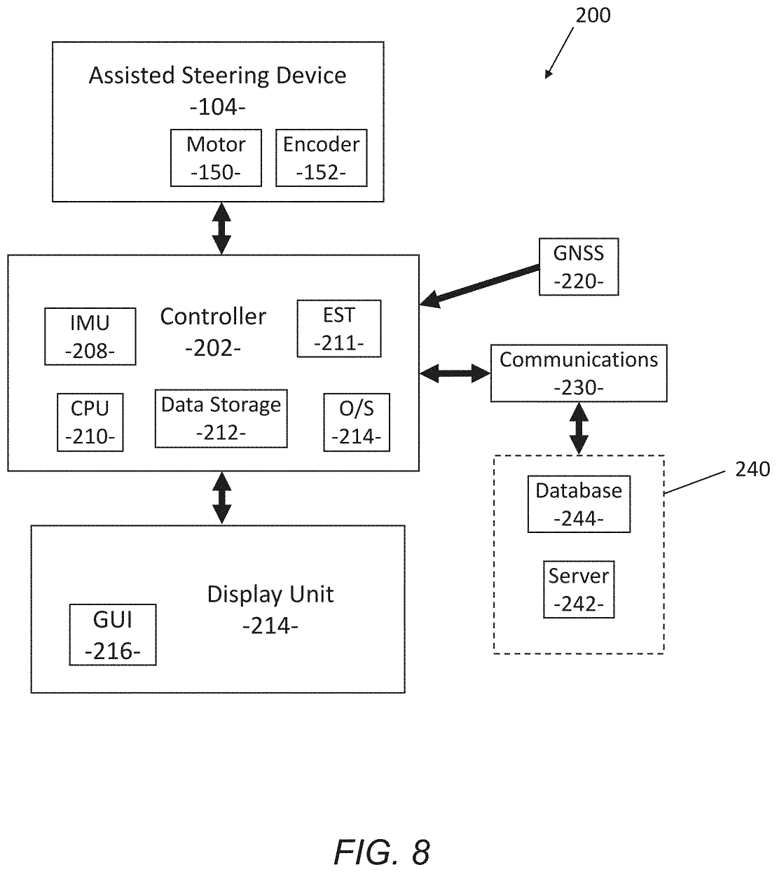

FIG. 8 is a system diagram providing further detail about one example of an automatic steering system 200 according to various implementations. Like the system 100 depicted in FIG. 7, the automatic steering system 200 includes a controller 202 in communication with an assisted steering device 104. The assisted steering device 104 is configured to be mounted to a vehicle steering wheel (e.g., as shown in FIG. 1) and to move the wheel in response to commands received from the controller 202. For example, in various implementations the assisted steering device 104 includes a motor drive unit (MDU) that includes a motor 150 and an encoder 152, as would be readily appreciated and is shown in the incorporated references discussing various steering systems.

As shown in FIG. 8, the controller 202 is operationally coupled and in communication with a separate display unit 214. It is appreciated that certain of these displays 214 may include touchscreens, while others are equipped with interface components such as a keyboard, mouse, and/or other device for interacting with the system 200. The display unit 214 provides a graphical user interface (GUI) 216 that allows an operator to interact with the system 200.

According to various implementations, the controller 202 includes one or more processing and computing components for implementing various technologies disclosed herein and elsewhere. As shown in FIG. 8, some of the components of the controller 202 can include an inertial measurement unit (IMU) 208, a CPU or processor 210, data storage 212, and an operating system 214. In the depicted implementation the controller 202 also includes a state estimator 211. The estimator 211, the CPU 210, data storage 212, IMU 208, and/or other components of the controller may process input data and enable the various features and process steps described with respect to various implementations of automatic steering systems described herein.

It should be appreciated that the various controller, estimator, and other system components are in operational communication with one another via wired or wireless connections and are configured to perform processes and execute commands to implement operations and features described herein. Further, it should be appreciated that while depicted separately in FIG. 8, in various implementations one or more portions of the system 200 may be housed together within a common module. For example, in some cases the controller 202, estimator 211, and/or assisted steering device 104 may be part of a single module. In some cases the controller 202, estimator, and the display unit 214 may be part of a single component. Various other combinations of functionality are likewise contemplated.

In various implementations, the automatic steering system 200 is also operationally integrated with a GNSS or GPS unit 220, such as a GPS 7500, such that the system 200 is configured to input positional data for use in defining boundaries, locating the vehicle, plotting guidance, and the like, as will be readily appreciated. As an example, in some cases the controller 202 (e.g., the controller itself and/or the estimator 211 and/or another component of the controller) is configured to determine (e.g., estimate) the current position and/or trajectory of the vehicle (e.g., a vehicle pose) using data from the GNSS/GPS unit 220 and/or the IMU 208.

As will be appreciated, the IMU 208 includes one or more sensors (e.g., a combination of accelerometers and gyroscopes) that measure and report sensor data that includes vehicle movement data such as specific forces, angular rates, and/or orientations of the vehicle. In some cases the automatic steering system may also or instead use on-vehicle camera systems such as stereo cameras, radar, LIDAR, or RGB cameras to estimate the true vehicle curvature (e.g., vehicle pose) through one or more methods such as, for example, optic flow or some other localization or simultaneous localization and mapping (SLAM) methodology.

In various implementations the system 200 also includes a communications component 230 configured for sending and receiving data to one or more cloud-based locations 240 for processing and storage. As examples, data may be transmitted to and from a remote server 242, database 244, and/or other cloud computing components readily understood in the art. Such connections by the communications component 230 can be made wirelessly via understood internet and/or cellular technologies such as Bluetooth, Wi-Fi, LTE, 3G, 4G, or 5G connections and the like. It is understood that in certain implementations, the communications component 230 and/or cloud 240 components comprise encryption or other data privacy components such as hardware, software, and/or firmware security aspects. In various implementations, the operator or enterprise manager or other third parties are able to receive notifications such as adjustment prompts and confirmation screens on their mobile devices, and in certain implementations can review the plotted guidance paths and make adjustments via their mobile phones.

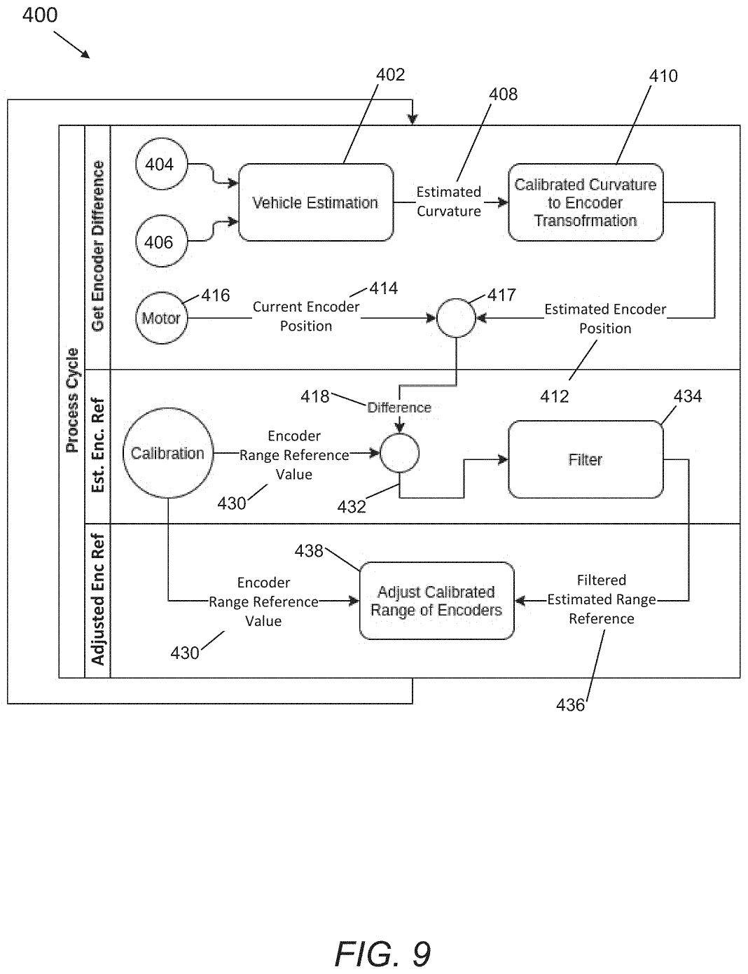

FIG. 9 is a flow diagram illustrating a method 400 for adjusting the calibration of an automatic steering system according to various implementations. In the method as shown in this example, the automatic steering system (e.g., via a controller, estimator, and/or other computing circuitry) estimates the actual curvature of the vehicle's trajectory and then uses the estimate to adjust the calibration of the vehicle's steering wheel encoder. Estimating the vehicle's curvature enables the steering system to evaluate and correct the steering calibration without needing to measure or determine the actual curvature exhibited by the vehicle. Accordingly, the steering system can adjust the steering calibration without an additional encoder, wheel angle sensor, or other techniques normally needed for measuring the actual curvature.

A first part of the method 400 involves determining whether any difference exists between the current, calibrated vehicle curvature and an estimate of the actual curvature of the vehicle. As shown in FIG. 9, in some implementations the method 400 determines the curvature difference by comparing corresponding encoder positions.

In various implementations a steering system generates an estimate of the actual vehicle curvature using sensor data that includes positional data and/or data from onboard sensors. In the example in FIG. 4, the steering system receives positional data from a geolocation data source 404, such as a GPS source. The system also receives vehicle movement data 406, such as acceleration and orientation measurements from an onboard inertial measurement unit (IMU). According to various implementations, the steering system uses the positional data and vehicle movement data as inputs for a Kalman filter analysis. The system conducts the filter analysis to generate a vehicle pose, which is shown in FIG. 9 as a “vehicle estimation” 402. According to various implementations, the estimated vehicle curvature (e.g., vehicle estimation 302) is conducted by an estimator, such as the estimator 211 shown in FIG. 8. Other types of analyses can similarly be used to generate a vehicle pose.

According to various implementations, vehicle heading and vehicle velocity are two parts of the vehicle pose output by the filter analysis. The first derivative of the heading, known as the heading rate or yaw rate, is then used with the vehicle velocity, v, to determine the estimated curvature 408 of the vehicle according to the following relationship:

$${κ}_{est} = \frac{\dot{ψ}}{v}$$

in which \dot{ψ} represents the heading rate (also referred to as heading rate-of-change or yaw rate), ν represents the vehicle's velocity, and κₑₛₜ represents the estimated curvature 408.

Before comparing the estimated curvature 408 to the calibrated curvature currently indicated by the encoder, the steering system performs a transformation 410 to generate an estimated encoder position 412. The estimated encoder position 412 represents a physical orientation of the steering encoder that would result in the estimated curvature 408. As shown in FIG. 9, the system utilizes a calibrated curvature-to-encoder transformation 410 to generate the estimated encoder position 412. The computation of the estimated encoder position 412 can in some cases be represented as:

EncoderPosₑₛₜ=ComputeEncoder(κₑₛₜ)

in which ComputeEncoder(κₑₛₜ) represents the curvature-to-encoder transformation 410.

The curvature-to-encoder transformation 410 can be accomplished using a number of suitable linear and/or nonlinear conversions. According to various implementations, the transformation 410 is determined according to the following linear transformation:

$${EncoderPos}_{est} = ( {EncoderPos}_{max} - {EncoderPos}_{min} ) \times \frac{( {κ}_{est} - {κ}_{min} )}{( {κ}_{max} - {κ}_{min} )} + {EncoderPos}_{min}$$

in which EncoderPosₘₐₓ and EncoderPosₘᵢₙ are the maximum and minimum positions of the encoder, respectively, and κₘₐₓ and κₘᵢₙ are the maximum and minimum curvatures, respectively, achievable by the steering system. In some cases the estimated encoder position 412 is determined as a number of encoder counts.

Returning to FIG. 9, the steering system also receives a measurement of the current position 414 of the optionally calibrated encoder from a motor drive unit (MDU) and/or the steering motor 416. As used herein, this measurement is also referred to as a current encoder position, EncoderPos_{cur}. In some cases the motor or MDU includes a Hall-effect sensor that measures the position (e.g., current rotation) of the motor and encoder as a number of encoder counts.

Once both the estimated encoder position 412 and the current encoder position 414 are determined, the steering system then compares 417 the positions to determine a difference 418 in encoder positions:

diff=EncoderPos_{cur}−EncoderPosₑₛₜ

In some cases the difference 418 may be determined as a number of encoder counts. As previously noted, the difference 418 between the current and estimated encoder positions also represents the difference between the estimated vehicle curvature 408 and the current vehicle curvature.

According to various implementations, the steering system corrects the steering calibration by adjusting the range of the steering encoder. In some cases, the adjustment includes shifting the range of encoder values. The method 400, shown in the example of FIG. 9, includes determining a reference value 430 for the calibrated encoder range. The system uses this reference 430 of the calibrated encoder range, Enc_Ref_{cal}, and the difference 418 between the current and estimated encoder positions to generate an estimated range reference value 432, Enc_Refₑₛₜ, of the steering encoder:

Enc_Refₑₛₜ=Enc_Ref_{cal}+diff

According to some implementations, the estimated range reference 432 is processed by a filter 434 such as a Kalman filter to provide a filtered estimated range reference 436, Enc_Ref_{filtered} In some cases, filtering in this manner can reduce the effects of noise on the computed value. Certain implementations can make use of a rolling average. As an example, in some cases the steering system computes an average of multiple values of the estimated range reference value to improve the accuracy of the estimate:

$${Enc\_Ref}_{filtered} = \frac{1}{b - a} {\sum }_{a}^{b} {Enc\_Ref}_{est}$$

wherein a and b represent the first and last values collected over a period of time. While one example of a filter is discussed, it should be appreciated that implementations that filter the estimated encoder range value are not limited to any specific filter. Other types of data conditioning or filtering that may be used include, but are not limited to, a rolling buffer, a first, second, or n^{th} order filter, a Kalman filter (e.g., such as the above example), and a linear-least squares filter.

After generating and filtering the estimated range reference, the method 400 includes adjusting or shifting 438 the calibrated encoder range to more closely match the estimated encoder range. Prior to the adjustment, the method includes determining the difference between the estimated range reference and the calibrated range reference. In various implementations the difference is represented as a number of encoder counts and/or encoder position values.

Assuming the calibrated range reference is different from the estimated range reference, the steering system adjusts 438 the calibrated range reference to be closer to, or the same as, the estimated range reference. In various implementations aligning the calibration range reference with the estimated range reference provides a simple and straightforward way to align the full range of encoder values. As an example, for a range of [−1500, Enc_Ref_{cal},1500], shifting the calibration range reference from Enc_Ref_{cal} to Enc_Ref_{cal}+1500 also shifts the range minimum, range maximum, and all points in between, resulting in a shifted range of [0, Enc_Ref_{cal}+1500, 3000].

In various cases the system dynamically shifts the entire calibrated encoder range up or down so that the calibrated range reference is closer to the estimated range reference. In some cases the system shifts the calibrated encoder range so that the calibrated range reference is the same as the estimated range reference.

In some implementations, the steering system shifts the calibrated encoder range toward the estimated encoder range in a single, one-time adjustment. In various implementations, though, the system shifts the calibrated encoder range in a series of incremental steps over a period of time. For example, in some cases each incremental shift is limited to about 25% or less of the total encoder range. In some cases each incremental shift is limited to about 1% (e.g., 0.5-1.5%) of the total encoder range per step. Other values are also possible.

The shifts may occur at any suitable frequency. In some cases the incremental shifts occur at an operating frequency based on the period of communication between the motor drive unit and the steering system controller. As an example, in various implementations the calibration shifts occur at a rate of 50 Hz. In some cases the step size and/or update frequency is designed to limit degradation of an operator's experience while using the system. In some cases successive iterations of the method 400 at 50 Hz may correct a misalignment of the encoder range in 5 seconds or less depending upon the degree of initial misalignment. In some cases the correction may occur within 3 seconds or less at 50 Hz.

Such short correction times can also provide a feasible way to initialize a steering system without an absolute encoder. In some cases an initial calibration procedure involves the operator moving the steering-wheel from full right to full left (e.g., from end-stop to end-stop or between points in which the wheels stop turning). Monitoring encoder values during the movement provides a size and maximum value of the encoder range. In such a case, where there is no absolute encoder, each power up of the system reports back an encoder value of zero. Alternate implementations utilize an absolute encoder, as would be appreciated.

If the operator did not perfectly center the steering wheel before beginning the initial calibration, the true wheel angle will not match the calibrated expectation. In such a case, for example, the steering wheel might be turned 10° to the right but the motor drive unit reports an encoder value of 0, which normally corresponds to the center of the expected range. (In some cases a range of [−2000, 2000] encoder counts is used to correspond to [−0.2 0.2] values of curvature.)

In this type of situation, implementations of the disclosed calibration method could initialize the calibration by estimating the vehicle curvature based on, for example, GPS and inertial movement measurements and then adjusting the encoder range to match the estimated curvature. While this initial calibration may in some cases be off by several degrees, successive iterations can quickly reduce the error within an acceptable time frame. For example, in some cases an initialization of this type can occur as quickly (e.g., within about 3 seconds of movement) as an automatic steering system takes to generate an initial vehicle pose.

As noted elsewhere herein, in various implementations the calibrated range reference value (also referred to herein as the “encoder range reference value”) and the estimated range reference value can be any suitable corresponding values in the calibrated encoder range and estimated encoder range, respectively. In some cases the calibrated range reference and estimated range reference may each refer to a minimum, a center, a maximum, or any other desirable point within the respectively ranges.

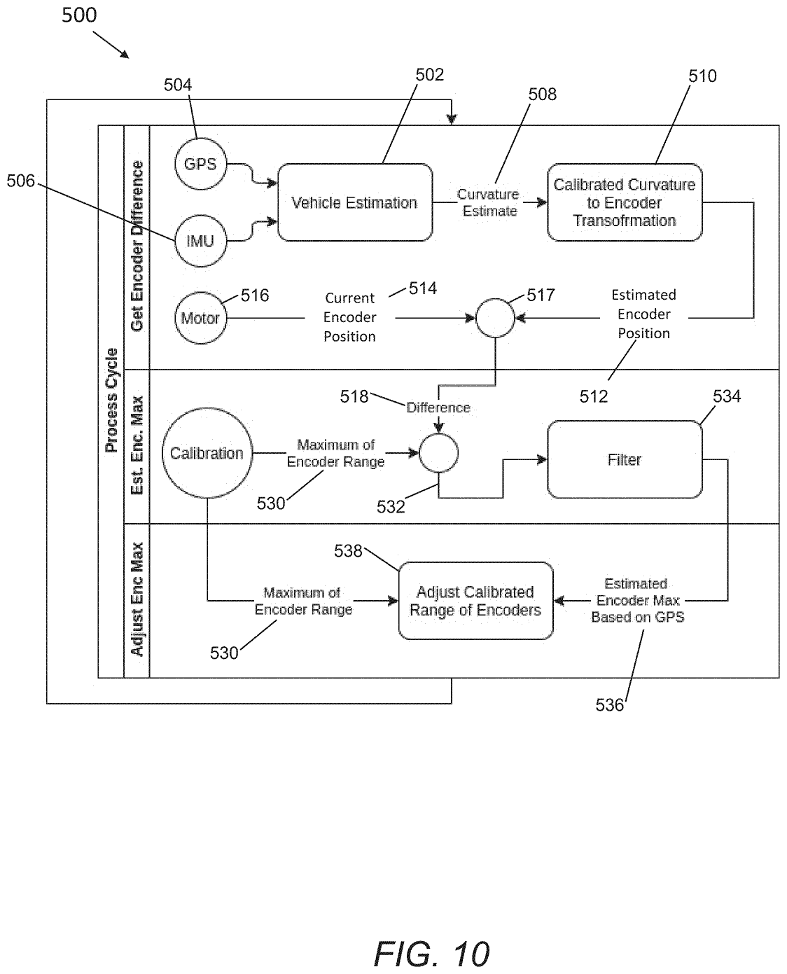

Turning now to FIG. 10, an example of an implementation using a calibrated range maximum and an estimated range maximum will be described. FIG. 10 is a flow diagram illustrating a method 500 for adjusting the calibration of an automatic steering system according to various implementations. In the method as shown in this example, the automatic steering system (e.g., via a controller, estimator, and/or other computing circuitry) first estimates the actual curvature of the vehicle's trajectory and then uses the estimate to adjust the calibration of the vehicle's steering wheel encoder. Estimating the vehicle's curvature enables the steering system to evaluate and correct the steering calibration without needing to determine the actual curvature exhibited by the vehicle. Accordingly, the steering system can adjust the steering calibration without an additional encoder, wheel angle sensor, or other techniques normally needed for measuring the actual curvature.

A first part of the method 500 involves determining whether any difference exists between the current, calibrated vehicle curvature and an estimate of the actual curvature of the vehicle. As shown in FIG. 10, in some implementations the method 500 determines the curvature difference by comparing corresponding encoder positions.

In various implementations a steering system generates an estimate of the actual vehicle curvature using positional data and data from onboard sensors. In the example in FIG. 10, the steering system receives sensor data that includes positional data from a geolocation data source, such as a GPS source 504. The system also receives sensor data that includes vehicle movement data, such as acceleration and orientation measurements, from an onboard inertial measurement unit (IMU) 506. According to various implementations, the steering system uses the positional data and vehicle movement data as inputs for a Kalman filter analysis. The system conducts the filter analysis to generate a vehicle pose, which is shown in FIG. 10 as a “vehicle estimation” 502. Other types of analyses can similarly be used to generate a vehicle pose.

According to various implementations, vehicle heading and vehicle velocity are two parts of the vehicle pose output by the filter analysis. The first derivative of the heading, known as the heading rate or yaw rate, is then used with the vehicle velocity, v, to determine the estimated curvature 508 of the vehicle according to the following relationship:

$${κ}_{est} = \frac{\dot{ψ}}{v}$$

in which \dot{ψ} represents the heading rate (also referred to as heading rate-of-change or yaw rate), ν represents the vehicle's velocity, and κₑₛₜ represents the estimated curvature 508.

Before comparing the estimated curvature 508 to the calibrated curvature currently indicated by the encoder, the steering system performs a transformation 510 to generate an estimated encoder position 512. The estimated encoder position 512 represents a physical orientation of the steering encoder that would result in the estimated curvature 508. As shown in FIG. 10, the system utilizes a calibrated curvature-to-encoder transformation 510 to generate the estimated encoder position 512. According to various implementations, the computation of the estimated encoder position is represented as:

EncoderPosₑₛₜ=ComputeEncoder(κₑₛₜ)

in which ComputeEncoder(κₑₛₜ) represents the curvature-to-encoder transformation 510.

The curvature-to-encoder transformation 510 can be accomplished using a number of suitable linear and/or nonlinear conversions. According to various implementations, the transformation 510 is determined according to the following linear transformation:

$${EncoderPos}_{est} = ( {EncoderPos}_{max} - {EncoderPos}_{min} ) \times \frac{( {κ}_{est} - {κ}_{min} )}{( {κ}_{max} - {κ}_{min} )} + {EncoderPos}_{min}$$

in which EncoderPosₘₐₓ and EncoderPosₘᵢₙ are the maximum and minimum positions of the encoder, respectively, and κₘₐₓ and κₘᵢₙ are the maximum and minimum curvatures, respectively, achievable by the steering system. In some cases the estimated encoder position 512 is determined as a number of encoder counts.

Returning to FIG. 10, the steering system also receives a measurement of the current position 514 of the optionally calibrated encoder from a motor drive unit (MDU) and/or the steering motor 516. As used herein, this measurement is also referred to as a current encoder position, EncoderPos_{cur}. In some cases the motor or MDU includes a Hall-effect sensor that measures the position (e.g., current rotation) of the motor and encoder as a number of encoder counts.

Once both the estimated encoder position 512 and the current encoder position 514 are determined, the steering system then compares 517 the positions to determine a difference 518 in encoder positions:

diff=EncoderPos_{cur}−EncoderPosₑₛₜ

In some cases the difference 518 may be determined as a number of encoder counts. As previously noted, the difference 516 between the current and estimated encoder positions also represents the difference between the estimated vehicle curvature 508 and the current vehicle curvature.

According to various implementations, the steering system corrects the steering calibration by adjusting the range of the steering encoder. In some cases, the adjustment includes shifting the range of encoder values. The method 500, shown in the example of FIG. 10, includes determining a reference value that is a maximum value 530 for the calibrated encoder range. The system uses this maximum 530 of the calibrated encoder range, Enc_Max_{cal}, and the difference 518 between the current and estimated encoder positions to generate an estimated range reference that is an estimated range maximum 532, Enc_Maxₑₛₜ, of the steering encoder:

Enc_Maxₑₛₜ=Enc_Max_{cal}+diff

According to some implementations, the estimated range maximum 532 is processed by a filter 534 such as a Kalman filter to provide a filtered estimated range maximum 536, Enc_Max_{filtered}. In some cases, filtering in this manner can reduce the effects of noise on the computed value. Certain implementations can make use of a rolling average. As an example, in some cases the steering system computes an average of multiple values of the estimated range maximum to improve the accuracy of the estimate:

$${Enc\_Max}_{filtered} = \frac{1}{b - a} {\sum }_{a}^{b} {Enc\_Max}_{est}$$

wherein a and b represent the first and last values collected over a period of time. While one example of a filter is discussed, it should be appreciated that implementations that filter the estimated encoder range maximum are not limited to any specific filter. Other types of data conditioning or filtering that may be used include, but are not limited to, a rolling buffer, a first, second, or n^{th} order filter, a Kalman filter (e.g., such as the above example), and a linear-least squares filter.

After generating and filtering the estimated range maximum, the method 500 includes adjusting or shifting 538 the calibrated encoder range to more closely match the estimated encoder range. Prior to the adjustment, the method includes determining the difference between the estimated range maximum and the calibrated range maximum. In various implementations the difference is represented as a number of encoder counts and/or encoder position values.

Assuming the calibrated range maximum is different from the estimated range maximum, the steering system adjusts 538 the calibrated range maximum to be closer to, or the same as, the estimated range maximum. In various implementations aligning the calibration range maximum with the estimated range maximum provides a simple and straightforward way to align the full range of encoder values. As an example, for a range of [−1500, 1500], shifting the maximum 1500 to 3000 also shifts the range minimum and all points in between, resulting in a shifted range of [0, 3000].

In various cases the system dynamically shifts the entire calibrated encoder range up or down so that the calibrated range maximum is closer to the estimated range maximum. In some cases the system shifts the calibrated encoder range so that the calibrated range maximum is the same as the estimated range maximum.

In some implementations, the steering system shifts the calibrated encoder range toward the estimated encoder range in a single, one-time adjustment. In various implementations, though, the system shifts the calibrated encoder range in a series of incremental steps over a period of time. For example, in some cases each incremental shift is limited to about 25% or less of the total encoder range per step. In some cases each incremental shift is limited to 1%, or about 1% (e.g., 0.5-1.5%), of the total encoder range per step. Other values are also possible.

The shifts may occur at any suitable frequency. In some cases the incremental shifts occur at an operating frequency based on the period of communication between the motor drive unit and the steering system controller. As an example, in various implementations the calibration shifts occur at a rate of 50 Hz. In some cases the step size and/or update frequency is designed to limit degradation of an operator's experience while using the system. In some cases successive iterations of the method 400 at 50 Hz may correct a misalignment of the encoder range in 5 seconds or less depending upon the degree of initial misalignment. In some cases the correction may occur within 3 seconds or less at 50 Hz.

Such short correction times can also provide a feasible way to initialize a steering system without an absolute encoder. In some cases an initial calibration procedure involves the operator moving the steering-wheel from full right to full left (e.g., from end-stop to end-stop or between points in which the wheels stop turning). Monitoring encoder values during the movement provides a size and maximum value of the encoder range. In such a case, where there is no absolute encoder, each power up of the system reports back an encoder value of zero. Alternate implementations utilize an absolute encoder, as would be appreciated.

If the operator did not perfectly center the steering wheel before beginning the initial calibration, the true wheel angle will not match the calibrated expectation. In such a case, for example, the steering wheel might be turned 10° to the right but the motor drive unit reports an encoder value of 0, which normally corresponds to the center of the expected range. (In some cases a range of [−2000, 2000] encoder counts is used to correspond to [−0.2 0.2] values of curvature.)

In this type of situation, implementations of the disclosed calibration method could initialize the calibration by estimating the vehicle curvature based on GPS and inertial movement measurements and then adjusting the encoder range to match the estimated curvature. While this initial calibration may be off by several degrees, successive iterations can quickly reduce the error within an acceptable time frame. For example, in some cases an initialization of this type can occur as quickly (e.g., within about 3 seconds of movement) as an automatic steering system takes to generate an initial vehicle pose.

Although the disclosure has been described with reference to preferred embodiments, persons skilled in the art will recognize that changes may be made in form and detail without departing from the spirit and scope of the disclosed apparatus, systems and methods.

What is claimed is:

1. An automatic steering system for an agricultural vehicle, comprising:
an assisted steering device configured to mount to a steering wheel of an agricultural vehicle, the assisted steering device comprising a motor and an encoder comprising a calibration range; and
a controller or an estimator operatively coupled to the assisted steering device and configured to adjust the calibration range, the adjusting comprising:
generating an estimated curvature for the vehicle based on a pose of the agricultural vehicle;
generating an estimated encoder position of the encoder based on the estimated curvature;
determining a current encoder position of the encoder; and
adjusting the calibrated encoder range based on the estimated encoder position and the current encoder position.

2. The automatic steering system of claim 1, wherein the adjusting further comprises generating the pose of the agricultural vehicle based on at least one of geolocation data and IMU data.

3. The automatic steering system of claim 1, wherein generating the estimated encoder position comprises using a curvature-to-encoder transformation for the encoder.

4. The automatic steering system of claim 1, wherein the calibration range comprises a calibration range reference, and wherein the adjusting of the calibration range further comprises
comparing the estimated encoder position and the current encoder position,
generating an estimated range reference based on the calibration reference and the comparison of the estimated and current encoder positions, and
adjusting the calibration range based on the estimated range reference and the calibration range reference.

5. The automatic steering system of claim 4, wherein the calibration range reference comprises a maximum of the calibration range and the estimated range reference comprises a maximum of the estimated calibration range.

6. The automatic steering system of claim 4, wherein the adjusting of the calibration range further comprises
filtering a plurality of values of the estimated range reference to generate a filtered estimated range reference, and
adjusting the calibration range based on the calibration range reference and the filtered estimated range reference.

7. The automatic steering system of claim 4, wherein adjusting the calibration range comprises shifting the calibration range toward the estimated calibration range.

8. The automatic steering system of claim 7, wherein shifting the calibration range comprises shifting the calibration range in a plurality of steps.

9. The automatic steering system of claim 8, wherein each of the plurality of steps comprises a shift of the calibration range toward the estimated calibration range by about 25% or less of the calibration range.

10. An automatic steering system for a vehicle, comprising:
an assisted steering device configured to mount to a steering wheel of a vehicle, the assisted steering device comprising a motor and an encoder comprising a calibrated encoder range comprising a calibrated range reference; and
a controller configured to adjust the calibrated encoder range, the adjusting comprising:
generating an estimated curvature for the vehicle based on sensor data;
generating an estimated encoder position based on the estimated curvature;
determining a current encoder position;
generating an estimated range reference based on the calibrated range reference and a comparison of the estimated encoder position and the current encoder position;
filtering a plurality of values of the estimated range reference to generate a filtered estimated range reference;
determining a difference between the calibrated range reference and the filtered estimated range reference; and
adjusting the calibrated encoder range based on the difference.

11. The automatic steering system of claim 10, wherein the sensor data comprises at least one of geolocation data and IMU data.

12. The automatic steering system of claim 10, wherein the sensor data is derived from one or more of GPS, accelerometers, gyroscopes, camera systems, radar and LIDAR.

13. The automatic steering system of claim 10, wherein the calibrated range reference comprises a maximum of the calibrated encoder range and the estimated range reference comprises a maximum of the estimated encoder range.

14. The automatic steering system of claim 10, wherein adjusting the calibrated encoder range comprises shifting the calibrated encoder range toward the estimated encoder range.

15. The automatic steering system of claim 14, wherein shifting the calibrated encoder range comprises shifting the calibrated encoder range in a plurality of steps over a period of time.

16. The automatic steering system of claim 15, wherein each of the plurality of steps comprises a shift of the calibrated encoder range toward the estimated encoder range by about 25% or less of the calibrated encoder range.

17. A method for adjusting the calibration of an automatic steering system of an agricultural vehicle, the method comprising:
generating an estimated curvature of an agricultural vehicle based on sensor data, the agricultural vehicle comprising an automatic steering system comprising a steering sensor comprising a calibration range comprising a calibration range reference;
generating, with a controller or an estimator, an estimated steering position of the agricultural vehicle based on the estimated curvature;
determining a current steering position of the agricultural vehicle;
comparing, with the controller or the estimator, the estimated steering position and the current steering position;
generating, with the controller or the estimator, an estimated range reference based on the calibration range reference and the comparison of the estimated and current steering positions;
filtering, with the controller or the estimator, a plurality of values of the estimated range reference to generate a filtered estimated range reference; and
adjusting the calibration range based on the calibration range reference and the filtered estimated range reference.

18. The method of claim 17, wherein the sensor data comprises at least one of geolocation data and IMU data.

19. The method of claim 17, wherein the calibration range reference comprises a maximum of the calibration range and the estimated range reference comprises a maximum of the estimated range.

20. The method of claim 17, wherein adjusting the calibration range comprises shifting the calibration range toward the estimated range in a plurality of steps.
